(19) United States
(12) Patent Application Publication
(10) Pub. No.: US 2024/0244355 A1
(43) Pub. Date: Jul. 18, 2024

(54) PATH DETERMINATION APPARATUS, PATH DETERMINATION METHOD, AND PROGRAM

(71) Applicant: NIPPON TELEGRAPH AND TELEPHONE CORPORATION, Tokyo (JP)

(72) Inventors: Kojun KOSHIJI, Tokyo (JP); Hanami YOKOI, Tokyo (JP); Yasuharu KANEKO, Tokyo (JP); Tatsuya MATSUKAWA, Tokyo (JP); Mika ISHIZUKA, Tokyo (JP); Takafumi HAMANO, Tokyo (JP)

(73) Assignee: NIPPON TELEGRAPH AND TELEPHONE CORPORATION, Tokyo (JP)

(21) Appl. No.: 18/561,803

(22) PCT Filed: May 26, 2021
(86) PCT No.: PCT/JP2021/020086

§ 371 Date: Nov. 17, 2023

(51) Int. Cl. H04Q 11/00

(52) U.S. Cl. CPC H04Q 11/0062; H04Q 2011/0073

(57) ABSTRACT

A route determination device includes a memory and a processor configured to calculate, in a communication network including a plurality of nodes and edges connecting the nodes, weights of the edges using a plurality of parameters regarding the edges or the nodes; and determine a first route from a start point node to an end point node in the communication network based on the weights of the edges.

### TECHNICAL FIELD

The present invention relates to a route determination device, a route determination method, and a program.

### BACKGROUND ART

In a communication network including a plurality of nodes and edges connecting the nodes, a technology has been known that searches for an appropriate route between a start point node and an end point node using, for example, Dijkstra's algorithm.

Furthermore, a technology has been known that searches for a route while considering a plurality of parameters using multidimensional order when comparing the costs at nodes in searching for a route using Dijkstra's algorithm (see, for example, Patent Literature 1).

### CITATION LIST

### Patent Literature

Patent Literature 1: JP 2018-037028 A

### SUMMARY OF INVENTION

### Technical Problem

In a path design of an optical transmission network, for example, determining an optimal route from a start point node to an end point node in consideration of a plurality of parameters including distances, nodes to be connected, and transmission planes is common. In such a case, according to the technology disclosed in Patent Literature 1, an appropriate route from the start point node to the end point node can be determined in consideration of the plurality of parameters.

However, in this method, in a case where the number of types of parameters to be considered increases, the man-hour to be referred increases, and thus, there arises an issue that the calculation amount increases and the efficiency of route search decreases.

An embodiment of the present invention has been made in view of the above issue, and enables efficient determination of an appropriate route even in a case where the number of types of parameters to be considered increases in a communication network including a plurality of nodes and edges connecting the nodes.

### Solution to Problem

In order to solve the above issue, a route determination device according to an embodiment of the present invention includes a weight calculation unit that, in a communication network including a plurality of nodes and edges connecting the nodes, calculates weights of the edges using a plurality of parameters regarding the edges or the nodes, and a route determination unit that determines a first route from a start point node to an end point node in the communication network based on the weights of the edges.

### Advantageous Effects of Invention

According to an embodiment of the present invention, an appropriate route can be efficiently determined even in a case where the number of types of parameters to be considered increases in a communication network including a plurality of nodes and edges connecting the nodes.

### BRIEF DESCRIPTION OF DRAWINGS

FIG. 1 is a diagram illustrating a configuration example of a route determination system according to the present embodiment.

FIG. 2 is a diagram illustrating a configuration example of a route determination device according to the present embodiment.

FIG. 3A is a diagram (1) illustrating a configuration example of an optical transmission network according to the present embodiment.

FIG. 3B is a diagram (2) illustrating a configuration example of the optical transmission network according to the present embodiment.

FIG. 3C is a diagram (3) illustrating a configuration example of the optical transmission network according to the present embodiment.

FIG. 4A is a diagram (1) illustrating an example of a network information DB according to the present embodiment.

FIG. 4B is a diagram (2) illustrating an example of the network information DB according to the present embodiment.

FIG. 5 is a flowchart illustrating an example of weight calculation processing according to the present embodiment.

FIG. 6 is a flowchart illustrating an example of route determination processing according to the present embodiment.

FIG. 7A is a diagram (1) for describing route search according to the present embodiment.

FIG. 7B is a diagram (2) for describing the route search according to the present embodiment.

FIG. 7C is a diagram (3) for describing the route search according to the present embodiment.

FIG. 8 is a diagram illustrating an example of a hardware configuration of a computer.

### DESCRIPTION OF EMBODIMENTS

Hereinafter, an embodiment of the present invention (present embodiment) will be described with reference to the drawings. The embodiment to be described below is merely an example, and an embodiment to which the present invention is applied is not limited to the following embodiment.

### <System Configuration>

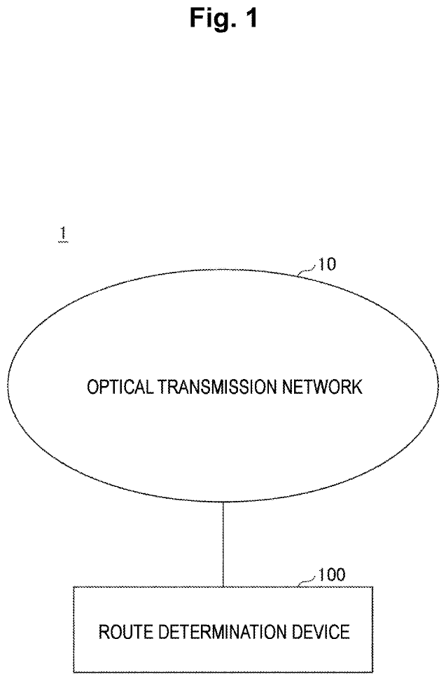

FIG. 1 is a diagram illustrating a configuration example of a route determination system according to the present embodiment. The route determination system 1 includes a route determination device 100 that is a computer that determines an appropriate route from a start point node to an end point node in an optical transmission network 10 in consideration of a plurality of parameters including distances, nodes to be passed through, and transmission planes.

The optical transmission network (communication network) 10 is a backbone network such as an Internet protocol (IP) communication network that implements communication using optical signals. Note that the optical transmission network 10 is an example of a communication network including a plurality of nodes and edges connecting the nodes. Here, the nodes include, for example, a communication device or a communication building included in the optical transmission network 10. The edges include a transmission path such as an optical fiber. Note that the edges may be referred to as links.

### <Configuration of Route Determination Device>

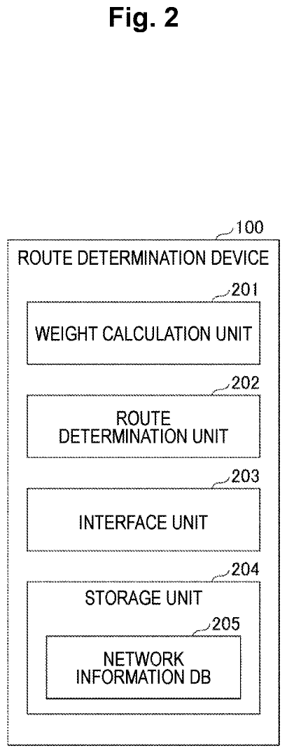

FIG. 2 is a diagram illustrating a configuration example of the route determination device according to the present embodiment. The route determination device 100 implements, for example, a weight calculation unit 201, a route determination unit 202, an interface unit 203, a storage unit 204, and the like by executing a predetermined program. Note that the respective functional elements described above may be distributed and arranged in a plurality of computers. At least part of the functional elements described above may be implemented by hardware.

The weight calculation unit 201 calculates the weight of edges using, for example, a plurality of parameters regarding the edges including distances, transmission planes, and nodes to be connected. For example, the weight calculation unit 201 acquires a plurality of parameters regarding edges or nodes from a network information database (DB) 205 stored in the storage unit 204, and calculates the weight of each of the edges included in the optical transmission network 10. Furthermore, the weight calculation unit 201 stores the calculated weight of each of the edges in the network information DB 205.

In the route determination unit 202, the weight calculation unit 201 determines an appropriate route (first route) from a start point node to an end point node in the optical transmission network 10 based on the weight of each of the edges stored in the network information DB 205. For example, the route determination unit 202 applies Dijkstra's algorithm to obtain the shortest route from the start point node to the end point node. Dijkstra's algorithm is a method of setting weights indicating how much cost (for example, distance) is required to pass through nodes or edges to the nodes and the edges included in a communication network, and determining a route having the smallest weight. However, the route determination unit 202 may perform route search by a method other than Dijkstra's algorithm.

In this manner, the weight calculation unit 201 calculates the weights of the edges for an objective function of the plurality of parameters in a case where the plurality of parameters needs to be considered as the weights of the edges or the nodes to be passed through at the time of route search. Therefore, the route determination unit 202 can efficiently determine an appropriate route from the start point node to the end point node using the weights of the edges calculated by the weight calculation unit 201.

The Interface unit 203 provides a user interface (UI) by which a user uses a route determination function provided by the route determination device 100, an application programming interface (API) by which a user uses the route determination function provided by the route determination device 100 from another device or the like, and the like. For example, a user (or another device) can set search conditions including a start point node, an end point node, and the like in the optical transmission network 10 using the interface unit 203. Furthermore, a user (or another device) can acquire a result of route determination processing by the route determination device 100 and the like using the interface unit 203.

The storage unit 204 stores various types of information including the network information DB 205, data, and the like. The network information DB 205 is a database in which topology information indicating a connection relationship between the nodes and the edges in the optical transmission network 10, the plurality of parameters and attribute information regarding the edges or the nodes, the weights of the edges calculated by the weight calculation unit 201, and the like are stored.

### (Configuration Example of Optical Transmission Network)

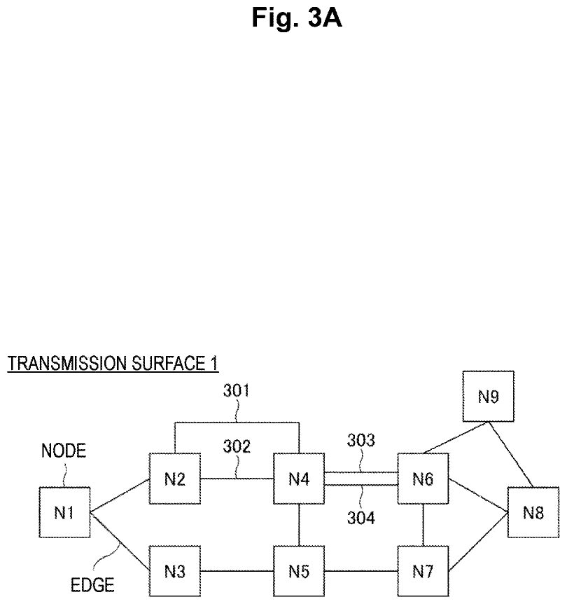

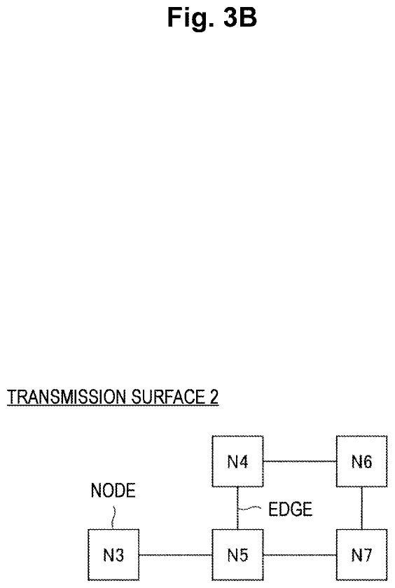

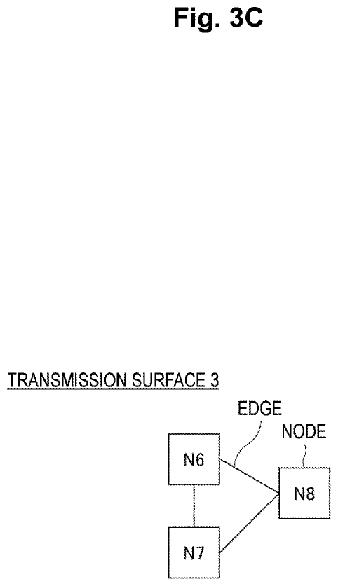

FIGS. 3A to 3C are diagrams illustrating configuration examples of the optical transmission network 10 according to the present embodiment. In an actually operated optical transmission network, a node, an edge, or the like may be added along with an increase in communication demand. Furthermore, there are two types of addition including a case where addition is locally performed on a node or an edge having insufficient resources (hereinafter referred to as local addition) and a case where addition is planarly performed on nodes or edges including surrounding nodes or edges (hereinafter referred to as planar addition).

In a case where local addition is performed, for example, a transmission plane 1 illustrated in FIG. 3A has topology in which a plurality of edges exists in the same sections, such as edges 301 and 302 connecting a node “N2” and a node “N4” or edges 303 and 304 connecting a node “N4” and a node “N6”.

On the other hand, in a case where planar addition is performed, an optical transmission network obtained by the addition is distinguished as a network (subnetwork) different from the existing optical transmission network (transmission plane 1 in FIG. 3A), such as a transmission plane 2 illustrated in FIG. 3B and a transmission plane 3 illustrated in FIG. 3C. In the present embodiment, the existing network illustrated in FIG. 3A is referred to as the transmission plane 1, the network obtained by addition illustrated in FIG. 3B is referred to as the transmission plane 2, and the network obtained by addition illustrated in FIG. 3C is referred to as the transmission plane 3.

Here, the following description assumes that the optical transmission network 10 includes the transmission plane 1, the transmission plane 2, and the transmission plane 3. Note that the transmission plane 1, the transmission plane 2, and the transmission plane 3 are examples of one or more transmission planes (subnetworks) including nodes and edges.

### (Example of Network Information DB)

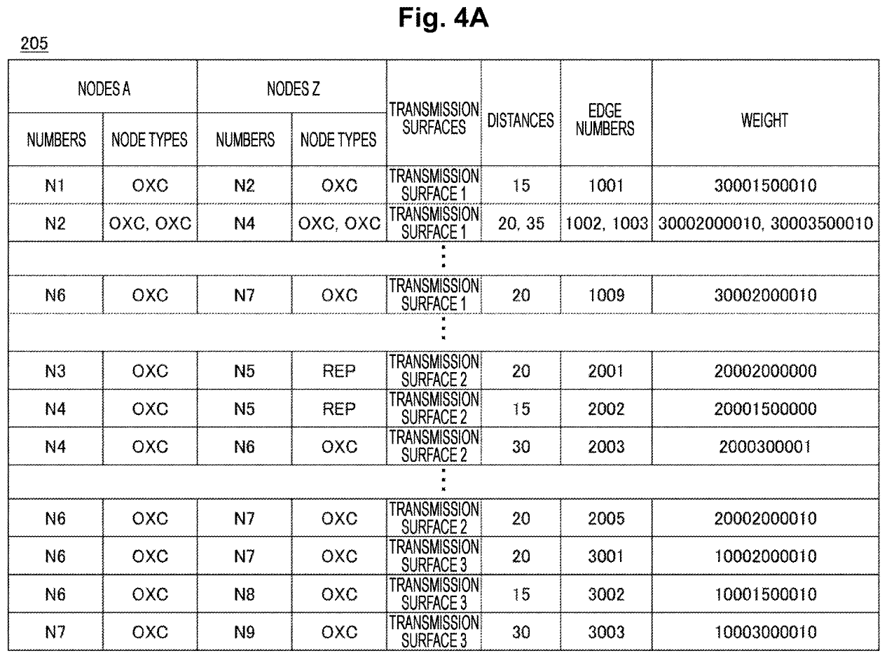

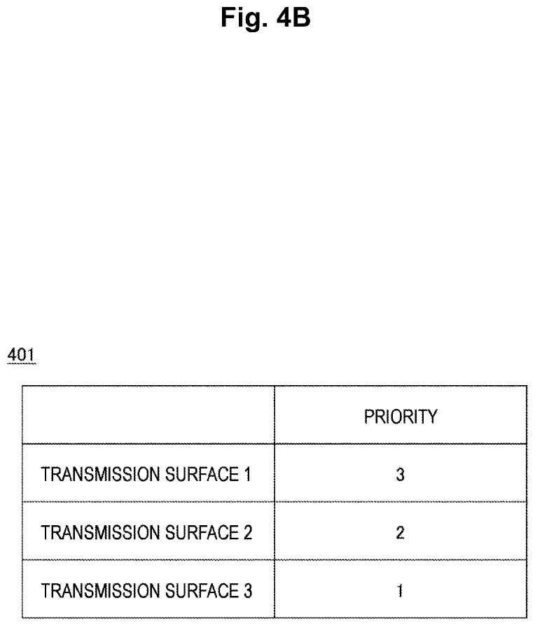

FIG. 4A is a diagram (1) illustrating an example of the network information DB according to the present embodiment. In the example of FIG. 4A, the network information DB 205 includes, as items, information such as “nodes A”, “nodes Z”, “transmission planes”, “distances”, “edge numbers”, and “weight”.

The “nodes A” include information of the “numbers” and the “node types” of nodes connected to one ends of the edges (nodes A). The “numbers” are identifiers for identifying the nodes A. The “node types” are attribute information of the nodes A in a case where there is a plurality of types of nodes. Here, it is assumed that there are three attributes of nodes of an optical cross connect (OXC), a repeater (REP), and a through (Thru).

Here, the OXC is an optical cross-connect that switches wavelength-multiplexed signals in units of wavelengths in the optical transmission network 10. The REP is an optical repeater that relays optical signals. Thru is, for example, a connection point of an optical fiber by fusion splicing or the like.

The “nodes Z” include information of the “numbers” and the “node types” of nodes connected to the other ends of the edges (nodes Z). The “numbers” are identifiers for identifying the nodes Z. The “node types” are attribute information of the nodes Z in a case where there is a plurality of types of nodes. For example, FIG. 4A illustrates that an edge having an edge number “1001” is connected between a node having a node number “N1” (node “N1”) and a node having a node number “N2” (node “N2”).

The “transmission planes” are information indicating in which of the transmission planes 1 to 3 described in FIGS. 3A to 3C, the edges are included. For example, in FIG. 4A, the edge having the edge number “1001” is included in the transmission plane 1. The “distances” are information indicating distances of the edges (distances between the nodes A and the nodes Z). The “edge numbers” are identifiers for identifying the edges. The “weight” is the weights of the edges calculated by the weight calculation unit 201.

Note that, in the optical transmission network 10, as described with reference to FIG. 3A, local addition may be performed, and thus, there are a case where a node A and a node Z have a plurality of node types, and a case where a plurality of edges is connected between a node A and a node Z. In a case where route search is performed on such topology, performing calculation using a multigraph is common. However, in a case where the topology is complicated, the calculation amount increases, and a lot of calculation time is required.

Therefore, in the present embodiment, for example, in a case where there is a plurality of edges between the same nodes such as edge numbers “1002” and “1003” of the network information DB 205 in FIG. 4A, attribute information of each of the edges is aggregated into one (listed). As a result, it can be handled as a simple graph. Furthermore, the weights of the edges are calculated for an objective function based on the aggregated attribute information, thereby reducing the calculation time.

Note that the items included in the network information DB illustrated in FIG. 4A are examples, and the number of items may be increased or decreased as necessary.

### <Flow of Processing>

Next, a flow of processing of a route determination method according to the present embodiment will be described.

### (Weight Calculation Processing)

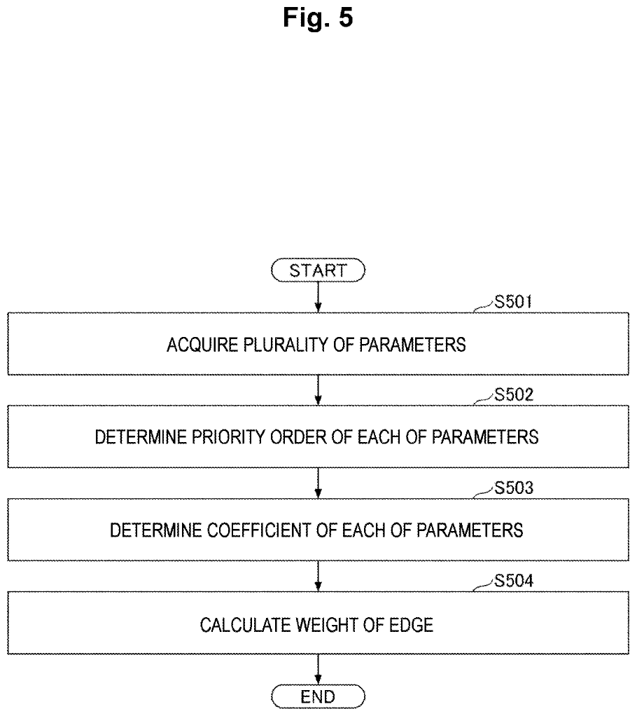

FIG. 5 is a flowchart illustrating an example of weight calculation processing according to the present embodiment. This processing illustrates an example of the weight calculation processing performed by the weight calculation unit 201 of the route determination device 100. For example, the weight calculation unit 201 performs the weight calculation processing illustrated in FIG. 5 for each of the “edge numbers” of the network information DB 205 as illustrated in FIG. 4A, and stores the calculated weights of the edges in the “weight” of the network information DB 205.

In step S501, the weight calculation unit 201 acquires a plurality of parameters for calculating the weight of an edge. For example, the weight calculation unit 201 acquires information such as a transmission plane, a distance, and the number of OXCs connected to the edge as a plurality of parameters for calculating the weights of the edges from the network information DB 205 as illustrated in FIG. 4A. At this point, the “weight” may not be stored in the network information DB 205.

In the optical transmission network 10, efficiently accommodating communication demand is important. For example, as illustrated in FIG. 3A, when communication demand that can be accommodated even in the transmission plane 3 having a small scale as illustrated in FIG. 3C is accommodated in the transmission plane 1 having a larger scale than the other transmission planes 2 and 3, there is a case where communication demand that can be accommodated only in the transmission plane 1 is generated and cannot be accommodated. Therefore, selecting a transmission plane suitable for accommodating communication demand based on a start point node and an end point node of the communication demand is a key for efficiently accommodating the communication demand. Therefore, a transmission plane is one of important parameters for calculating the weights of the edges.

Preferably, the network information DB 205 includes priority information 401 of the transmission planes as illustrated in FIG. 4B. As illustrated in FIG. 4B, the priority of the transmission planes 1 to 3 is set in the priority information 401 of the transmission planes. In the example of FIG. 4B, the transmission plane 3 having a smaller scale than the other transmission planes 1 and 2 is set to have the highest priority, and the transmission plane 1 having a larger scale than the other transmission planes 2 and 3 is set to have the lowest priority.

Furthermore, in path design of the optical transmission network 10, searching for a route in consideration of attenuation and distortion of an optical signal is important. As factors of attenuation and distortion of an optical signal, not only the distance but also the number of nodes to be passed through, the types of the nodes, and the like are important. For example, a repeater (REP) and a connection point (Thru) of an optical fiber by fusion splicing or the like have a small influence on an optical signal, but it is considered that an influence on an optical signal by an optical cross connect (OXC) being passed through should be considered. Therefore, the number of OXCs connected to the edge is also one of the important parameters for calculating the weights of the edges.

In step S502, the weight calculation unit 201 determines a priority order of the acquired parameters. Here, as an example, the priority of the transmission plane is determined to be the highest assuming the transmission plane>the distance>the number of OXCs.

Note that, as a method of determining the priority order of the parameters, for example, a user may set the priority order of the parameters using the interface unit 203. In this case, the weight calculation unit 201 determines the priority order of the parameters by reading the priority order of the parameters set by the user.

As another example, the priority order of the parameters may be determined such that the priority is set higher as the number of digits of the weight of a parameter is larger (alternatively, the priority is set higher as the number of digits of the weight of the parameter is smaller).

Note that, as the weight of the transmission plane, for example, a value of the priority of the priority information 401 of the transmission plane as illustrated in FIG. 4B may be used. As the weight of the distance, for example, a value of the distance input to the network information DB 205 may be used. As the number of OXCs connected to the edge, the number of OXCs stored in the network information DB 205 may be used.

In step S503, the weight calculation unit 201 determines a coefficient of each of the parameters. Note that, as a method of determining the coefficient of each of the parameters, for example, a user may set the coefficient of each of the parameters using the interface unit 203. In this case, the weight calculation unit 201 determines the coefficient of each of the parameters by reading the coefficient of each of the parameters set by the user.

As another example, the weight calculation unit 201 may determine the coefficient of each of the parameters based on the number of digits of a numerical value of each of the parameters using the following Formula (1).

$$\begin{matrix}[ Math . 1 ] & \\ {k}_{n} = {10}^{{\sum }_{i = n}^{N} ( {d}_{i} + a ( N - i ) )} & ( 1 )\end{matrix}$$

where kₙ is a coefficient for a parameter of a priority n (n is an integer of 1 or more), N is the number of a plurality of parameters, dₙ is the maximum number of digits in the parameter of the priority n, and “a” is a coefficient (integer value). Note that, when the weight of the entire route is summed, the number of digits of each of the parameters increases, and a numerical value of a parameter having a high priority order may be mixed. Setting the coefficient “a” avoids this issue.

In step S504, the weight calculation unit 201 weights the value of each of the parameters by a coefficient and adds weighted values of the parameters to calculate the weight of an edge using, for example, the following Formula (2).

$$\begin{matrix}[ Math . 2 ] & \\ Weight = {k}_{1} \times {p}_{1} + {k}_{2} \times {p}_{2} + … + {k}_{n} \times {p}_{n} & ( 2 )\end{matrix}$$

where kₙ is a coefficient for a parameter m of the priority n, and pₙ is a parameter of the priority n.

Furthermore, the weight calculation unit 201 stores the calculated weight in, for example, the “weight” of the network information DB 205 as illustrated in FIG. 4A.

Through the above processing, the route determination device 100 can obtain the network information DB 205 in which the “weight” of each of the edges is stored as illustrated in FIG. 4A.

### [Modification]

The weight calculation unit 201 may calculate the weight of the edge by multiplying the value of each of the parameters using, for example, the following Formula (3) instead of Formula (2).

$$\begin{matrix}[ Math . 3 ] & \\ Weight = {p}_{1} \times {p}_{2} \times … \times {p}_{n} & ( 3 )\end{matrix}$$

In this case, the weight calculation unit 201 can omit processing of steps S502 and S503 in the weight calculation processing illustrated in FIG. 5.

### (Route Determination Processing)

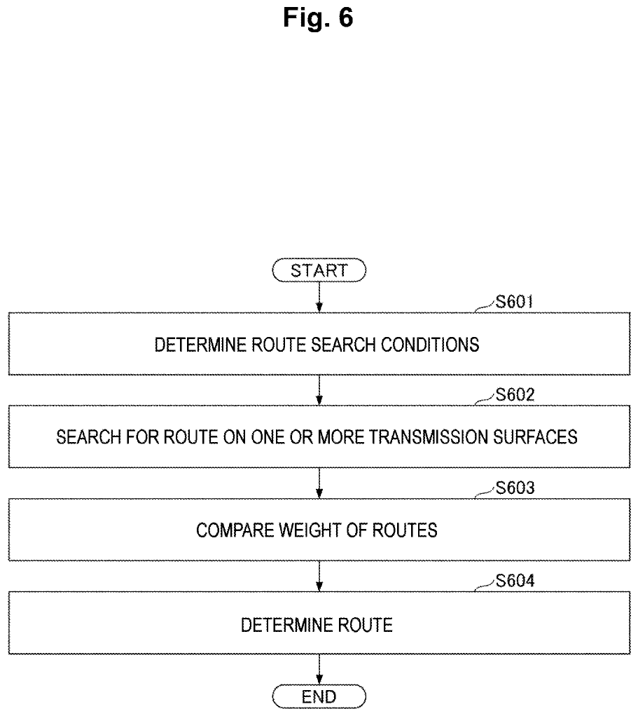

FIG. 6 is a flowchart illustrating an example of route determination processing according to the present embodiment. This processing illustrates an example of the route determination processing performed by the route determination unit 202 of the route determination device 100.

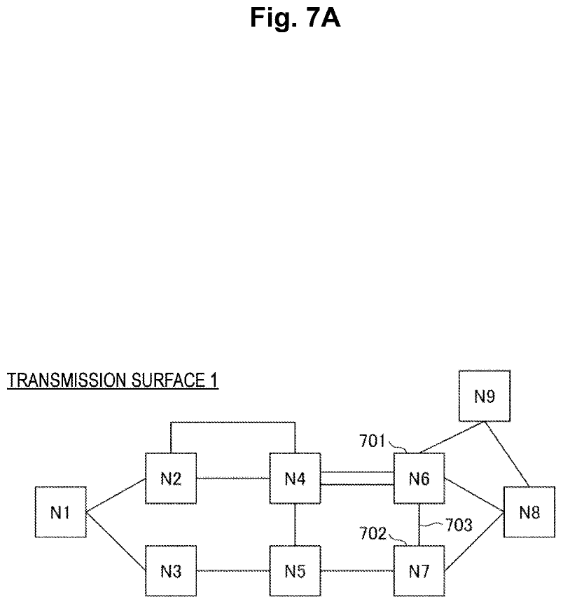

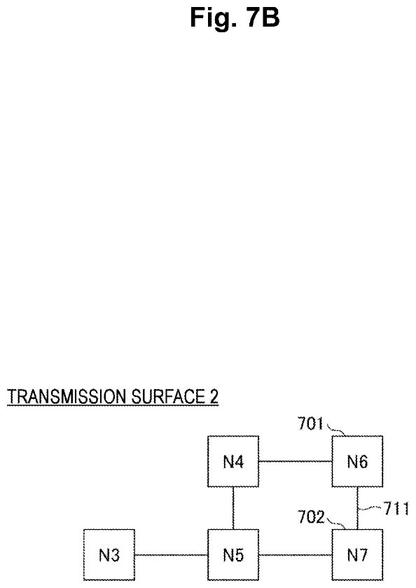

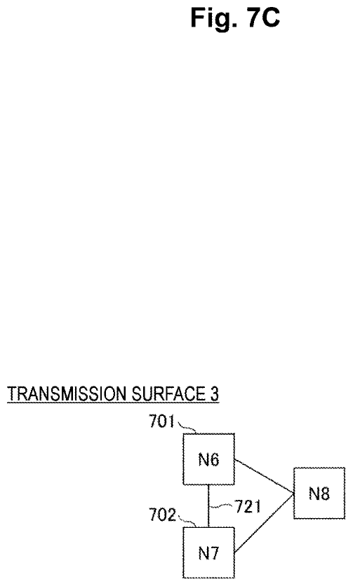

In step S601, the route determination unit 202 determines route search conditions. For example, the route determination unit 202 sets a start point node, an end point node, and the like received from a user (or another device) or the like using the interface unit 203 as route search conditions. Here, as an example for description, the following description assumes that the node “N6” is set as a start point node 701 and the node “N7” is set as an end point node 702 in the optical transmission network 10 as illustrated in FIGS. 7A to 7C.

In step S602, the route determination unit 202 obtains an appropriate route from the start point node 701 to the end point node 702 on one or more transmission planes included in the optical transmission network 10. For example, the route determination unit 202 obtains a route having the smallest weight from the start point node 701 to the end point node 702 using Dijkstra's algorithm on each of the transmission planes 1 to 3 as illustrated in FIGS. 7A to 7C. Note that the route determination unit 202 may perform route search by a method other than Dijkstra's algorithm.

For example, the shortest route obtained by the search on the transmission plane 1 as illustrated in FIG. 7A is a route passing through an edge 703. Similarly, the shortest route obtained by the search on the transmission plane 2 as illustrated in FIG. 7B is a route passing through an edge 711, and the shortest route obtained by the search on the transmission plane 3 as illustrated in FIG. 7C is an edge 721.

In step S603, the route determination unit 202 compares the weights of routes obtained by the search. For example, on the transmission plane 1, the edge 703 corresponds to an edge having an edge number “1009” of the network information DB 205 as illustrated in FIG. 4A, and the weight is “300020000010”. Therefore, the weight of the route obtained by the search on the transmission plane 1 is “300020000010”. Similarly, the weight of the route obtained by the search on the transmission plane 2 is “20002000010”, and the weight of the route obtained by the search on the transmission plane 3 is “10002000010”.

In step S604, the route determination unit 202 determines a route from the start point node 701 to the end point node 702 based on the weights compared in step S603. For example, since the weight of the route obtained by the search on the transmission plane 3 is the smallest, the route determination unit 202 determines the route obtained by the search on the transmission plane 3 as the optimal route.

Processing of FIGS. 6 and 7 described above enables the route determination device 100 to efficiently determine an appropriate route even in a case where the number of types of parameters to be considered increases in a communication network (optical transmission network 10) including a plurality of nodes and edges connecting the nodes.

### <Hardware Configuration Example>

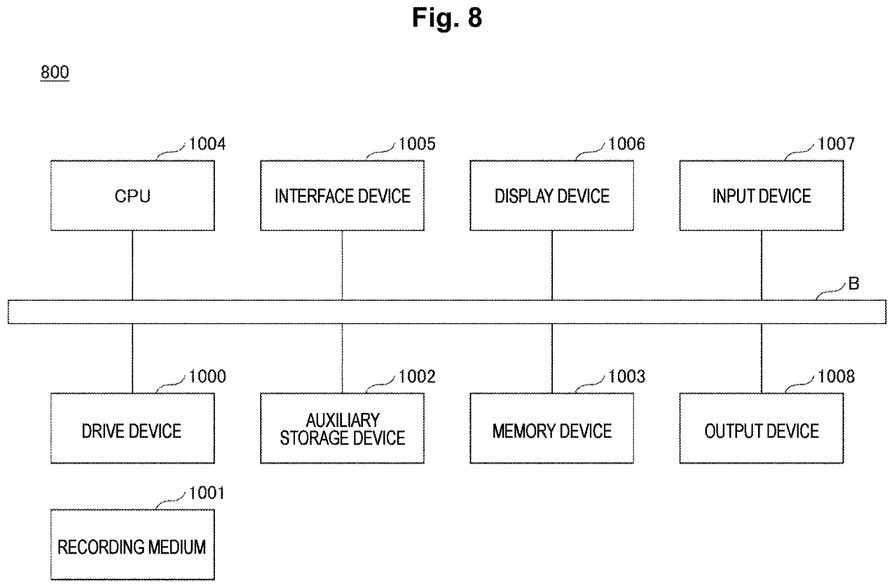

The route determination device 100 according to the present embodiment can be implemented, for example, by a computer 800 as illustrated in FIG. 8 being caused to execute a program in which the processing contents described in the present embodiment are described.

The above program can be stored and distributed by being recorded in a recording medium (portable memory or the like) that the computer 800 can read. Further, the program can be provided via a network such as the Internet or an electronic mail.

FIG. 8 is a diagram illustrating an example of a hardware configuration of the computer. The computer 800 in FIG. 8 includes a drive device 1000, an auxiliary storage device 1002, a memory device 1003, a central processing unit (CPU) 1004, an interface device 1005, a display device 1006, an input device 1007, and an output device 1008 that are connected to one another by a bus B.

The program for performing processing in the computer 800 is provided through a recording medium 1001 such as a CD-ROM or a memory card, for example. When the recording medium 1001 that stores the program is set in the drive device 1000, the program is installed from the recording medium 1001 into the auxiliary storage device 1002 via the drive device 1000. However, the program is not necessarily installed from the recording medium 1001, but may be downloaded from another computer via a network. The auxiliary storage device 1002 stores the installed program, and also stores necessary files, data, and the like.

In a case where an instruction to start the program is input, the memory device 1003 reads the program from the auxiliary storage device 1002, and stores the program therein. According to the program stored in the memory device 1003, the CPU 1004 implements the functions related to the respective components described in the present embodiment. The interface device 1005 is used as an interface for connecting to a network. The display device 1006 displays a graphic user interface (GUI) or the like by the program. The input device 1007 includes a keyboard and a mouse, buttons, a touch panel, and the like, and is used to input various operation instructions. The output device 1008 outputs a calculation result. Note that the route determination device 100 may not include the display device 1006 and/or the input device 1007.

### Effects of Embodiment

According to the route determination system 1 according to the present embodiment, in a case where there is a plurality of parameters to be considered at the time of route search, the plurality of parameters can be expressed as one weight by the weight of an edge being calculated for an objective function of the plurality of parameters. Therefore, for example, a route search method of efficiently obtaining a route based on the weight of an edge such as Dijkstra's algorithm can be applied.

Furthermore, the route determination system 1 stores the weight of an edge calculated by the weight calculation processing as illustrated in FIG. 5 in the network information DB 205 as illustrated in FIG. 4A together with the topology information of the optical transmission network 10. Therefore, the route determination system 1 can reduce the calculation amount by performing the route determination processing as illustrated in FIG. 6 using the network information DB 205.

Furthermore, in a communication network having complicated structure in which a plurality of edges exists between nodes, the route determination system 1 can simplify a graph by listing attribute information (a plurality of parameters) of nodes or edges included in the communication network. Therefore, the route determination system 1 can reduce the calculation amount of simulation for a communication network having complicated structure.

As described above, according to the present embodiment, an appropriate route can be efficiently determined even in a case where the number of types of parameters to be considered increases in the optical transmission network (communication network) 10 including a plurality of nodes and edges connecting the nodes.

### SUMMARY OF THE EMBODIMENT

The present description discloses a route determination device, a route determination method, and a program in at least the following clauses.

### (Clause 1)

A route determination device including
a weight calculation unit that, in a communication network including a plurality of nodes and edges connecting the nodes, calculates weights of the edges using a plurality of parameters regarding the edges or the nodes, and
a route determination unit that determines a first route from a start point node to an end point node in the communication network based on the weights of the edges.

### (Clause 2)

The route determination device according to the clause 1, in which
the communication network includes one or more transmission planes including the nodes and the edges, and
the plurality of parameters regarding the edges includes information of the transmission planes including the edges.

### (Clause 3)

The route determination device according to the clause 2, in which
the route determination unit
calculates a weight of a second route from the start point node to the end point node on each of the one or more transmission planes using the weights of the edges, and
determines the first route from among the second routes based on the weights of the second routes.

### (Clause 4)

The route determination device according to any one of the clauses 1 to 3, in which
the communication network is an optical transmission network, and
the plurality of parameters includes a number of optical cross-connects connected to the edges.

### (Clause 5)

The route determination device according to any one of the clauses 1 to 4 further including
a database in which topology information indicating a connection relationship between the nodes and the edges and the weights of the edges are stored, in which
the route determination unit determines the first route using the database.

### (Clause 6)

A route determination method performed by a computer, the route determination method including
processing of, in a communication network including a plurality of nodes and edges connecting the nodes, calculating weights of the edges using a plurality of parameters regarding the edges or the nodes, and
processing of determining a first route from a start point node to an end point node in the communication network based on the weights of the edges.

### (Clause 7)

A program causing a computer to perform processing, the processing including
processing of, in a communication network including a plurality of nodes and edges connecting the nodes, calculating weights of the edges using a plurality of parameters regarding the edges or the nodes, and
processing of determining a first route from a start point node to an end point node in the communication network based on the weights of the edges.

Although the present embodiment has been described above, the present invention is not limited to such a specific embodiment, and various modifications and changes can be made within the scope of the present invention described in the claims.

### REFERENCE SIGNS LIST

1 Route determination system
10 Optical transmission network (communication network)
100 Route determination device
201 Weight calculation unit
202 Route determination unit
205 Network information DB (database)
701 Start point node
702 End point node
1000 Drive device
1001 Recording medium
1002 Auxiliary storage device
1003 Memory device
1004 CPU
1005 Interface device
1006 Display device
1007 Input device
1008 Output device

1. A route determination device comprising:
a memory; and
a processor configured to:
calculate, in a communication network including a plurality of nodes and edges connecting the nodes, weights of the edges using a plurality of parameters regarding the edges or the nodes; and
determine a first route from a start point node to an end point node in the communication network based on the weights of the edges.

2. The route determination device according to claim 1, wherein the communication network includes one or more transmission planes each of which includes part of the nodes and the edges of the communication network, and
wherein the plurality of parameters regarding the edges includes information of the transmission planes including the edges.

3. The route determination device according to claim 2, wherein the processor calculates a weight of a second route from the start point node to the end point node on each of the one or more transmission planes using the weights of the edges, and
determines the first route from among the second routes based on the weights of the second routes.

4. The route determination device according to claim 1, wherein the communication network is an optical transmission network, and
wherein the plurality of parameters includes a number of optical cross-connects connected to the edges.

5. The route determination device according to claim 1, further comprising:
a database in which topology information indicating a connection relationship between the nodes and the edges and the weights of the edges are stored,
wherein the processor determines the first route using the database.

6. A route determination method performed by a computer that includes a memory and a processor, the route determination method comprising:
in a communication network including a plurality of nodes and edges connecting the nodes, calculating weights of the edges using a plurality of parameters regarding the edges or the nodes; and
determining a first route from a start point node to an end point node in the communication network based on the weights of the edges.

7. A non-transitory computer-readable recording medium having computer-readable instructions stored thereon, which, when executed, cause a computer to perform processing, the processing comprising:
in a communication network including a plurality of nodes and edges connecting the nodes, calculating weights of the edges using a plurality of parameters regarding the edges or the nodes; and
determining a first route from a start point node to an end point node in the communication network based on the weights of the edges.
